(19) United States
(12) Patent Application Publication
(10) Pub. No.: US 2002/0023162 A1
(43) Pub. Date: Feb. 21, 2002

(54) Method for integrating network elements on communications system

(76) Inventors: Hyung-Nam Ahn, Soul (KR); Dong-Hyun Lee, Seoul (KR)

Correspondence Address: BAKER & BOTTS, 30 ROCKEFELLER PLAZA, NEW YORK, NY, 10112

(21) Appl. No.: 09/861,357

(22) Filed: May 18, 2001

(30) Foreign Application Priority Data
Aug. 18, 2000 (KR) 2000-47844

(51) Int. Cl. G06F 15/16

(52) U.S. Cl. 709/230

(57) ABSTRACT

A method integrates network elements in an integration Internet protocol (ALL-IP) network based on a next generation mobile communications network. For the purpose, the method integrates a packet control function (PCF) for interworking a radio access network (RAN) with a packet data network and a packet data serving node (PDSN) function for performing a function as an access node to enable data terminals to communicate with the packet data network through the RAN, and integrates, in case of providing a mobile Internet protocol (mobile IP) service, a mobile Internet Protocol foreign agent (mobile IP FA) of the PDSN and a link layer termination function of a mobile station in the PCF.

### FIELD OF THE INVENTION

The present invention relates to a method for integrating network elements such as a packet control function (PCF) and a packet data serving node (PDSN) function in next generation mobile communications network based integration Internet protocol (ALL-IP) networks such as 3^{rd} generation partnership projects-2 (3GPP2), international mobile telecommunications (IMT-2000) and universal mobile telecommunications service to thereby so as to provide an effective network structure and a data service function, and a computer readable recording medium in which a program implementing the method is recorded.

### BACKGROUND OF THE INVENTION

Referring to FIG. 1, there is shown a constitutional diagram of a conventional 3GPP2 network.

A radio access network (RAN) 12 comprises a base station controller (BSC) and a base station transceiver subsystem. A mobility management and authentication of a mobile station (MS) 11 is provided via a visitor location register (VLR) 13 and a home location register (HLR) 14.

If a basic authentication for a data call is completed, the RAN 12 establishes a virtual link for a generic routing encapsulation (GRE) protocol with a packet data serving node (PDSN) 16.

The PDSN 16 establishes a point-to-point protocol (PPP) link with the MS 11, provides subscriber authentication functionality via a remote authentication dial-in user service (RADIUS) server and transfers accounting information to the RADIUS server.

When providing mobile IP services, the PDSN 16 performs a foreign agent (FA) function. A home agent 15, which exists on a home network of an IP address of the MS, carries out functions such as a position information management, a tunnel establishment and so on.

As described above, a conventional packet control function (PCF) is an interworking system of the RAN 12 for interworking with a packet data network, for example, IP Network and the PDSN 16 performs its function as an access node so as to link mobile data terminals accessed through the RAN 12 to the packet data network. Therefore, the RAN 12 was totally separated with the packet data network.

However, in a next 3GPP2 network or ALL-IP network, a trend is to integrate the above all networks to one IP network and the conventional BSC, PCF and PDSN are considered as a wireless access gateway (WAG) system. Therefore, access nodes of the data terminals are gradually moved into lower levels of a network as the above networks are being integrated into the WAG.

Specially, in the IMT-2000 network and the ALL-IP network structure under standardization in the 3GPP2, as described in FIGS. 1 and 2, systems of the PCF and the PDSN are independently configured.

Although the PCF can exist inside of the BSC system or be implemented as a separate system located outside of the BSC system, most of developers designs the PCF as an independent system in order to provide an effective mobility in a radio access network.

The PCF uses a scheme of linking the RAN and a packet data network (PDN), which is referred to as “RP interface,” so as to link data of the MS transmitted through the RAN to the PDSN. There is provided a tunneling function through a virtual link connection of each subscriber for a data transmission in the RP link and a GRE protocol encapsulation and decapsulation of user data. Further, a temporary buffering function and a packet segmentation function are performed so as to transmit link layer packets to be supplied from the PDSN to the MS through an air interface.

The PDSN performs a PPP/GRE protocol process to thereby process the packets from the PCF. In this case, if the PCF and the PDSN are separated into different systems, there are problems as follows.

First, when the user packet of the MS is transmitted, a transmission delay increases compared with that of an integrated system because a store and forward process is performed whenever the packet is passed by a network element.

Second, there is ineffectiveness of the data transmission, which is induced by a header overlapping of the GRE/PPP in the RP link. Particularly, on the process of developing a next IPv6(HA), if an edge of the link layer of the MS is located at the PDSN, the RP link should maintain a tunneling scheme of an IPv4(GFA). Accordingly, in a developing aspect to the next Ipv6, it is reasonable to process the link layer protocol of the MS of the PDSN in the PCF.

As shown above, in order to perform the interworking between the RAN and the IP network in the 3GPP2 IMT-2000 network, the RAN required the PCF and the IP network needed the PDSN. Therefore, there needs a method capable of integrating the PCF and the PDSN so as to provide an effective network structure and a data service function in the IMT-2000 network and the ALL-IP network.

### SUMMARY OF THE INVENTION

It is, therefore, a primary object of the present invention to provide a method for integrating network elements such as a packet control function (PCF) and a packet data serving node (PDSN) in next generation mobile communications network based integration Internet protocol (ALL-IP) networks to thereby provide an effective network structure and a data service function, and a computer readable recording medium in which a program implementing the method is recorded.

In accordance with an aspect of the present invention, there is provided a method for integrating network elements in an integration Internet protocol (ALL-IP) network based on a next generation mobile communications network, the method including the steps of: integrating a packet control function (PCF) for interworking a radio access network (RAN) with a packet network and a packet data service node (PDSN) function for performing a function as an access node for connecting data subscribers accessed through the RAN to the packet network; and in case of providing a mobile Internet protocol (IP) service, integrating a mobile Internet IP foreign agent (FA) of the PDSN and a link layer edge function of a mobile station in the PCF.

In accordance with another aspect of the present invention, there is provided a computer program product for use in a next generation mobile communications network based integration Internet protocol (ALL-IP) network including a processor, including: a computer readable medium for implementing a function for integrating a packet control function (PCF) for interworking a radio access network (RAN) with a packet data network and a packet data serving node (PDSN) function performing a function as an access node for connecting data terminals accessed through the RAN to the packet data network, and employing, in case of providing a mobile Internet protocol (mobile IP) service, a mobile Internet Protocol (Mobile IP) foreign agent (FA) of the PDSN and a link layer termination function for a mobile station in the PCF.

### BRIEF DESCRIPTION OF THE DRAWINGS

The above and other objects and features of the present invention will become apparent from the following description of preferred embodiments given in conjunction with the accompanying drawings, in which:

FIG. 1 shows a constitutional diagram of a conventional 3GPP2 network;

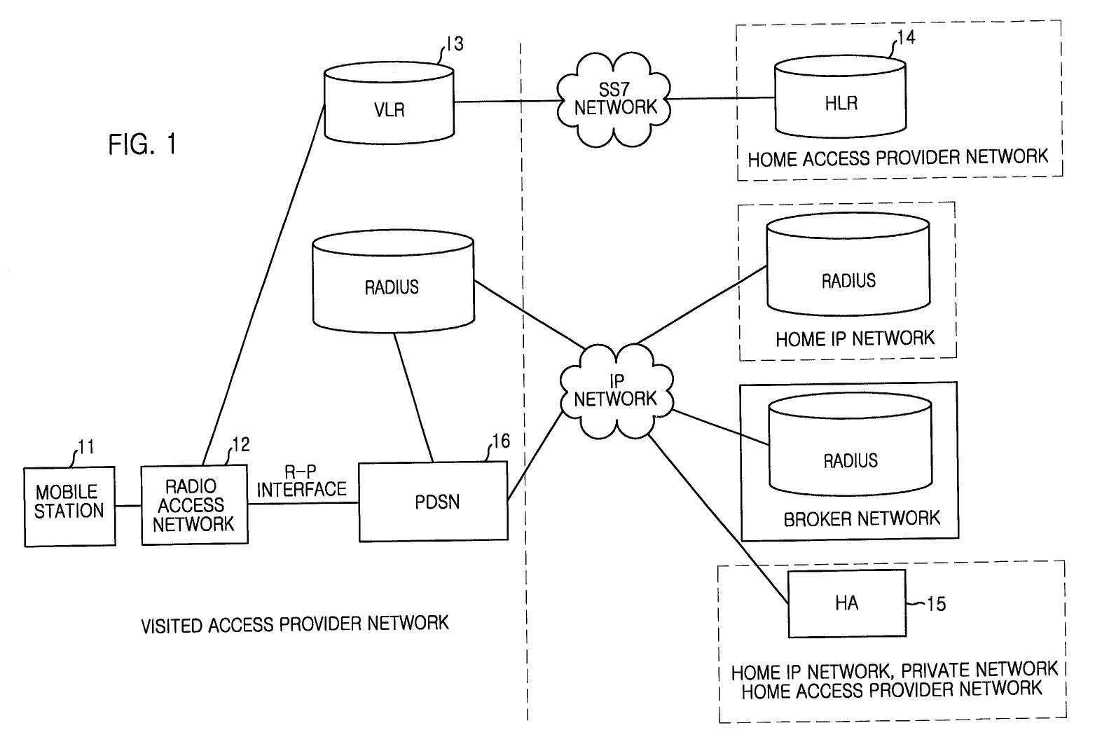

FIG. 2 exemplifies a constitutional diagram of a 3GPP2 ALL-IP network in accordance with the present invention;

FIG. 3 is a constitutional diagram of a protocol for a PCF having a mobile IP foreign agent function in accordance with the present invention; and

FIG. 4 provides a flowchart representing a call processing procedure of a method for integrating network elements in accordance with the present invention.

### DETAILED DESCRIPTION OF THE PREFERRED EMBODIMENTS

Hereinafter, with reference to the drawings, some of the preferred embodiments of the present invention will be explained in detail.

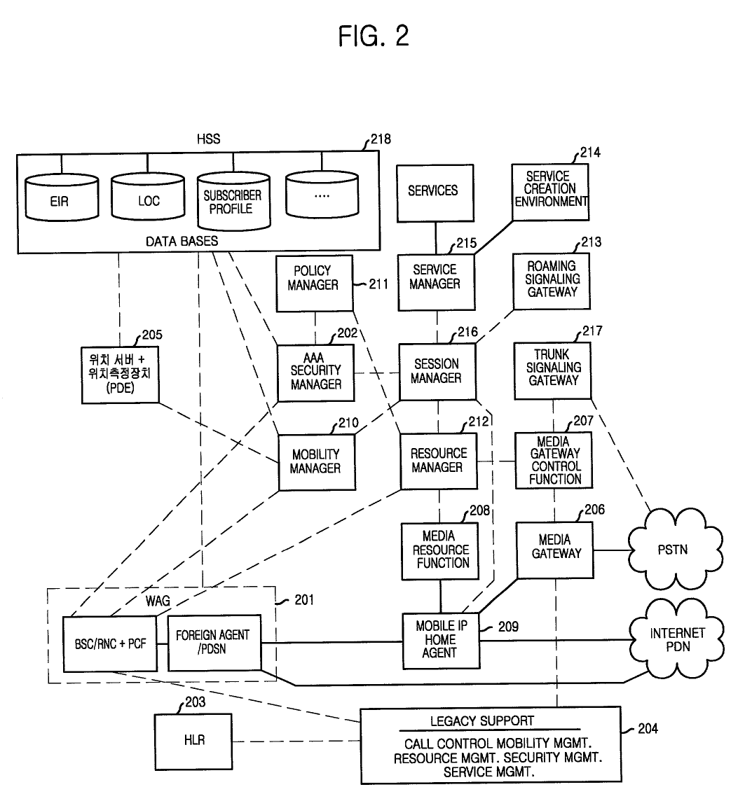

Referring to FIG. 2, there is shown a constitutional diagram of a 3GPP2 ALL-IP network in accordance with the present invention.

A WAG 201 implements a radio controller and a voice and data gateway function so as to interwork a conventional BSC, a PCF and a PDSN function by using one system.

The BSC controls and manages one or more base stations (BTS) and performs a signal scheme and a traffic related to a call processing, a mobility management, an MS management and the like. The RAN is composed of the BSC and the BTS.

The PCF can exist inside of the BSC system or be implemented as a separate system outside of the BSC system. The PCF links data of the MS transferred from the RAN to the PDSN.

The PDSN carries out a foreign agent (FA) function and acts as an edge for delivering calling and answering packets for the packet data of the MS to an appropriate path, and establishing and managing a link layer protocol of the MS.

An authorization/authentication/accounting (AAA) security manager 202 provides an Internet protocol function for supporting an authorization, authentication and accounting function.

A home location register (HLR) 203 contains information related to subscriber information, IP priority and whether authentication and resources for interdomain services are used or not.

A legacy support function unit 204 manages functions such as a call processing, a mobility management, a resource management, a security management, a service management and the like, which are provided in a conventional radio access network employing a line mode.

A location server 205 has functions such as location information and a moved location center and a position determination equipment (PDE) interworking function.

A media gateway 206 executes protocol and address converting functions when user data are provided onto a public data network or other private networks.

A media gateway control function 207 controls and manages the media gateways 206.

A media resource function 208 performs a management function of allocating and delocating resources of the media gateways 206.

A mobile IP home agent 209 manages care-of addresses such as IP addresses of a foreign agent or local addresses of mobile stations in a table form as location information for a mobile IP and performs a function of delivering transmission data for mobile stations through tunneling and encryption as occasion demands.

A mobility manager 210 carries out a function of managing a hand-off between the WAGs 201 or networks.

A policy manager 211 manages policy data and regulations and allows an interaction of various policies.

A resource manager 212 executes a function of managing resources required in providing services to network users.

A roaming signaling gateway 213 converts packet signals to a signal mode of a circuit switching network or performs the other way round.

A service creation environment function unit 214 provides an operator with an environment in which new services and applicative services can be created.

A service manager 215 manages a network authentication and all of voice and data service logics.

A session manager 216 establishes and manages hand-offs, states and sessions over some networks.

A trunk signaling gateway 217 converts signal modes between a public switched telephone network (PSTN) and a core network.

A home subscriber server 218 contains network elements such as AAA, HLR, EIR, LOC, UMS and the like.

An equipment identity register (EIR) acts as a database for equipment information.

A location related information database (LOC) provides location related information requested by the location server 205.

A policy repository stores data for the subscribers, multimedia use policies, the service quality, a valid time and path and so on.

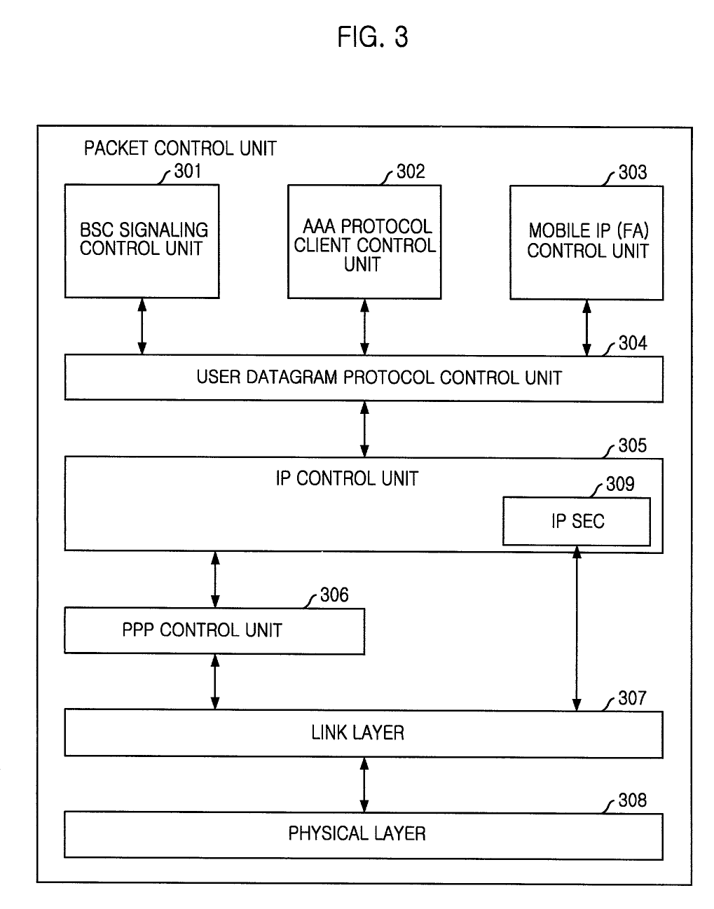

Referring to FIG. 3, there is shown a protocol structure of employing a mobile IP foreign agent function of the PDSN in the PCF.

In FIG. 3, a user datagram protocol (UDP) processing unit 304, an IP processing unit 305, an IP encryption unit 309 and a PPP processing unit 306 follow a protocol determined by Internet engineer task force (IETF). On the other hand, a link layer 307 employs an asynchronous transfer mode or an Ethernet.

A BSC interworking signal processing unit 301 processes diverse signals related to a resource management and a call processing of data calls delivered from the BSC.

An AAA protocol client processing unit 302 performs the authentication for linking the MS to the IP network through the use of the AAA protocol and supplies accounting information generated in the system to the AAA security manager 202.

A mobile IP foreign agent function processing unit 303 processes messages related to the MS and the mobile IP and manages a visitor list.

The PCF employing the mobile IP FA function of the PDSN includes as major functions the conventional PCF such as a dormant function for a packet data service, a function of establishing data paths with the BSC and a function of temporarily storing user packets, and the conventional PDSN function such as a PPP packet segmentation and assembly function, a FA function of the mobile IP, an IP in IP tunneling function, an IP encrypting function, an dynamic IP address allocating function, a path allocating and mobile IP message processing function and a remote authentication dial in user service (RADIUS) or DIAMETER client function. However, the PCF does not perform the conventional RP access signal processing.

Hereinafter, a process delivering packets will be described. The Packets transferred from the BSC are converted into a PPP frame through a combining process as occasion demands. After the PPP processing, the IP packets of the MS are delivered to the IP network according to a general routing method. Then, the packets received from the IP network are regenerated to the PPP frame and then divided into a size pertinent to the size of a radio link protocol of the RAN.

Herein, the IP packets transmitted to the networks are conveyed to a next node through a path determined by a routing protocol.

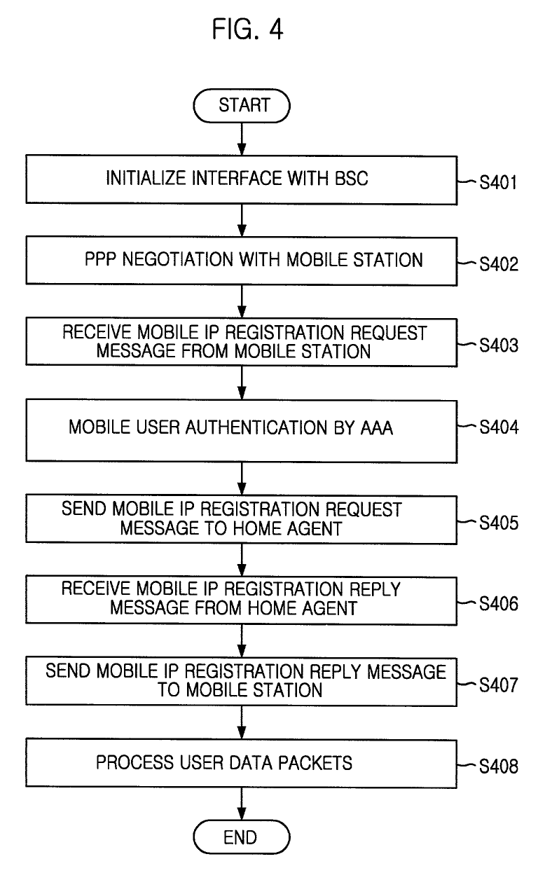

Referring to FIG. 4, there is illustrated a flowchart of showing a procedure of a call processing for the network element integrating method in accordance with the present invention. This procedure integrates the PCF and the PDSN in order to provide an effective network structure and a data service function.

In step 401, the PCF employing the mobile IP FA function of the PDSN performs the call processing so as to establish a data transmission path with the BSC at the BSC interworking signal processing unit 301 and initializes a data link between the BSC and a packet processor having the functions of the PDSN.

In step 402, the PPP is negotiated with the MS through the data path established from the MS to the packet processor at the PPP protocol processing unit 306. At this time, in case a simple IP service is provided, in the PPP negotiation process, the subscriber authentication is performed at the AAA protocol client processing unit 302 and an IP address is allocated if necessary.

Then, after the PPP is established, when a mobile IP message is received from the MS in step 403, the subscriber authentication is executed by using the AAA protocol such as RADIUS or DIAMETER in step 404.

The mobile IP FA function processing unit 303 carries out as a foreign agent the following functions defined by IETF RFC 2002 and TIA/EIA/IS-835. That is, the mobile IP FA function processing unit 303 delivers the mobile IP registration message received from the MS to the mobile IP home agent 209 in step 405 to thereby register the location of the MS, receives a response to the registration from the mobile IP home agent 209 in step 406 and transfers the response to the MS. Moreover, the mobile IP FA function processing unit 303 establishes a tunneling with the mobile IP home agent 209 and further sets the encryption of the IP if necessary.

If the registration of the mobile IP is completed, in step 408, the packets transmitted to or received from the MS are processed.

As described above, the present invention provides following effects compared with the conventional configuration in which the PCF and the PDSN are separated.

First, there is no need to establish the virtual link and to use the GRE protocol since the RP link between the PCF and the PDSN disappears.

Second, the GRE/PPP overhead on the RP link disappears, so that the traffic load of the network is reduced. As a result, the data transmission delay decreases as two network elements are integrated as one.

Third, the next Ipv6 is easily employed. That is, in the conventional networks, since all packets should be transmitted only through the PDSN, both of the PCF and the PDSN have a burden in processing the packets. However, in accordance with the present invention, the packets are processed in one system and it is possible to self-route the packets to networks, so that the data transmission can be distributed.

Fourth, the present invention is pertinent to moving the FA function of the 3GPP2 to the RAN.

While the present invention has been described with respect to the particular embodiments, it will be apparent to those skilled in the art that various changes and modifications may be made without departing from the spirit and scope of the invention as defined in the following claims.

What is claimed is:

1. A method for integrating network elements in an integration Internet protocol (ALL-IP) network based on a next generation mobile communications network, the method comprising the steps of:
integrating a packet control function (PCF) for interworking a radio access network (RAN) with a packet network and a packet data service node (PDSN) function for performing a function as an access node for connecting data subscribers accessed through the RAN to the packet network; and
in case of providing a mobile Internet protocol (IP) service, integrating a mobile Internet IP foreign agent (FA) of the PDSN and a link layer edge function of a mobile station in the PCF.

2. The method as recited in claim 1, wherein the PCF includes:
a user datagram protocol (UDP) processing unit;
an Internet protocol (IP) processing unit;
an Internet protocol encryption unit;
a point-to-point protocol (PPP) processing unit;
a link layer;
a physical layer;
a base station controller interworking signal processing unit for processing diverse signals related to a resource management and a data call received from a base station controller (BSC);
an authorization/authentication/accounting (AAA) protocol client processing unit for performing an authentication for accessing the IP network of a mobile station (MS) through an AAA protocol and a function of transferring accounting information generated in a system to an AAA security manager; and
a mobile IP FA function processing unit for processing messages related to the MS and the mobile IP and managing a visitor list.

3. The method as recited in claim 1, wherein the PCF includes:
a dormant function for a packet data service;
a function for installing a call with the BSC;
a function for temporarily storing user packets;
a function for dividing and combining PPP packets;
an FA function of the mobile IP;
an IP in IP processing function;
an IP encrypting function;
an IP address assigning function;
a routing and mobile IP message processing function; and
a remote authentication dial in user service (RADIUS) or DIAMETER client function, wherein there is no signal processing in the PCF by using an RP accessing scheme between the RAN and the packet network.

4. The method as recited in claim 1, wherein the PCF transfers packets through the steps of:
generating a perfect PPP frame by combining packets provided from the BSC;
delivering IP packets of the MS to an IP network according to a general routing scheme;
producing a PPP frame based on packets transferred from the IP network producing as a PPP frame;
dividing the PPP frame into a size pertinent to the size of a radio link protocol of the RAN; and
transmitting the divided frame.

5. The method as recited in claim 4, wherein the BSC interworking signal processing unit performs a call processing function so as to establish a data transmission path with the BSC and initializes a data access between the BSC and a packet processor having the function of the PDSN.

6. The method as recited in claim 4, wherein the PPP processing unit negotiates with the MS through the data path established from the MS to the packet processor.

7. The method as recited in claim 6, wherein the AAA protocol client processing unit performs a subscriber authentication when a simple IP service is provided, assigns an IP address if necessary, and processes the subscriber authentication by using a protocol if the mobile IP message is supplied from the MS.

8. The method as recited in claim 4, wherein the mobile IP FA function processing unit registers a location of the MS by transferring a mobile IP registration message received from the MS to a mobile IP home agent, receives a response from the mobile IP home agent, delivers the received response to the MS, establishes a tunneling with the mobile IP home agent and sets up an encryption of the IP if necessary.

9. An integration Internet protocol (ALL-IP) network based on a next generation mobile communications network including a processor, comprising:
a computer readable medium for implementing a function for integrating a packet control function (PCF) for interworking a radio access network (RAN) with a packet network and a packet data service node (PDSN) function performing a function as an access node for connecting data subscribers accessed through the RAN to the packet network, and employing, in case of providing a mobile Internet protocol (IP) service, a mobile Internet IP foreign agent (FA) of the PDSN and a link layer termination function of a mobile station in the PCF.
